(19) United States
(12) Patent Application Publication
(10) Pub. No.: US 2026/0278441 A1
(43) Pub. Date: Sep. 17, 2026

(54) ARTIFICIAL INTELLIGENCE DEVICE FOR GROUP-EQUIVARIANT QUANTUM NEURAL FUNCTIONALS FOR DENSITY FUNCTIONAL THEORY SIMULATION AND METHOD THEREOF

(71) Applicant: LG ELECTRONICS INC., Seoul (KR)

(72) Inventors: Jack Stephen BAKER, Toronto (CA); Thi Ha KYAW, Burlington (CA)

(73) Assignee: LG ELECTRONICS INC., Seoul (KR)

(21) Appl. No.: 19/567,897

(22) Filed: Mar. 16, 2026

Related U.S. Application Data
(60) Provisional application No. 63/771,683, filed on Mar. 14, 2025.

(51) Int. Cl. G06N 10/40; G06N 10/20; G06N 10/60

(52) U.S. Cl. CPC G06N 10/40; G06N 10/20; G06N 10/60

(57) ABSTRACT

A method for controlling an artificial intelligence (AI) device can include generating a real-space electron density for a target system, encoding a representation of the real-space electron density into a multi-qubit quantum state, processing the multi-qubit quantum state using a parameterized quantum circuit, in which the parameterized quantum circuit includes a quantum neural network configured to be equivariant to an orthogonal group O(3) or finite subgroups of the orthogonal group O(3), measuring an output of the parameterized quantum circuit to obtain spatial weighting coefficients, calculating an exchange-correlation (XC) energy contribution by combining the spatial weighting coefficients with one or more of analytical primitive energy-density terms, and outputting the exchange-correlation (XC) energy contribution.

### CROSS-REFERENCE TO RELATED APPLICATIONS

This non-provisional application claims priority under 35 U.S.C. § 119(e) to U.S. Provisional Application No. 63/771,683, filed on Mar. 14, 2025, the entirety of which is hereby expressly incorporated by reference into the present application.

### BACKGROUND

### Field

The present disclosure relates to a device and method for simulating ground-state molecular properties using group-equivariant quantum neural functionals, in the field of artificial intelligence. Particularly, the method can implement a hybrid architecture that integrates classical density functional theory with symmetry-twirled quantum circuits to provide enhanced accuracy for exchange-correlation energies.

### Discussion of the Related Art

Density functional theory (DFT) has become an underlying tool in computational chemistry and materials science, which allows researchers to simulate and predict the ground-state properties of complex molecular systems. For example, by framing the complex multi-electron problem in terms of electron density, classical DFT engines can efficiently calculate fundamental physical properties and accelerate the discovery of new materials and drugs.

However, classical DFT engines are severely hindered by the exchange-correlation (XC) functional, whose exact mathematical form remains elusive and is often too computationally complex for traditional computers to solve. Because this form is unknown, classical systems rely on heuristic approximations, such as the local density approximation (LDA). Accordingly, the outputs for highly correlated molecular systems are often inaccurate and fail to capture true quantum mechanical interactions, which can lead to suboptimal molecular models and reduced overall predictive effectiveness.

To overcome the limitations of classical approximations, various quantum computing and machine learning techniques have been proposed to model complex multi-electron interactions. However, existing quantum machine learning approaches face several challenges and often lack robust physical grounding.

For example, existing parameterized quantum circuits typically process input data without an inherent integration of fundamental physical symmetries. Thus, simple transformations of a physical system (e.g., altering its spatial orientation) can cause these standard models to output inconsistent and physically invalid results.

For example, when tasked with evaluating a chemical geometry, a generic quantum neural network (QNN) requires massive amounts of data augmentation which forces the quantum computer to train on every possible rotated and reflected orientation of the molecule to artificially learn the symmetry. This requires an exponential number of sampling measurements and quantum resources which is computationally expensive, and prone to unpredictable errors when presented with novel molecular geometries.

Thus, a need exists for an improved method and device that can accurately approximate the exchange-correlation functional while inherently respecting the physical spatial symmetries of molecular structures without requiring exponential training overhead.

Furthermore, a need exists for a framework that can guarantee this physical consistency by design. Such a method is needed to move beyond generic quantum neural networks and provide a mathematically rigorous, group-equivariant architecture to ensure that the simulated energy remains perfectly invariant to arbitrary 3D spatial orientations, thereby ensuring a more accurate and stable physical simulation.

Also, a need exists for a comprehensive hybrid framework that can systematically bridge classical hardware and quantum processors, leveraging DFT solvers to manage the overarching self-consistent field loops while deploying a group-equivariant quantum neural functional to resolve the exchange-correlation bottleneck.

### SUMMARY OF THE DISCLOSURE

The present disclosure has been made in view of the above problems and it is an object of the present disclosure to provide a device and method that can provide improved accuracy and physical consistency for simulating ground-state molecular properties. Further, the method can provide enhanced simulation reliability by implementing a hybrid framework that bridges classical density functional theory with a group-equivariant quantum neural functional to resolve the computationally complex exchange-correlation bottleneck and inherently guarantees spatial symmetry.

An object of the present disclosure is to provide a hybrid quantum-classical computing device and method for a group-equivariant quantum neural functional framework that can simulate ground-state molecular properties tailored to fundamental physical symmetries. The method can utilize a multi-component hybrid framework to systematically bridge classical density functional theory and quantum logic to generate and evaluate exact exchange-correlation energies. For example, a classical host module including a density functional theory (DFT) engine and an analytical primitive evaluator can first initialize an atomic system to generate an electron density grid along with unweighted classical primitive energy-density terms. Then, a classical-quantum interface can encode the classical density data into a multi-qubit quantum state for processing by a quantum neural functional module, which can utilize a parameterized quantum circuit configured with symmetry-twirled gates to process the data consistently regardless of the molecule's spatial orientation and return highly accurate spatial weighting coefficients. Further, an exchange-correlation assembly and integration module can combine the spatial weighting coefficients from the quantum hardware with the primitive energy terms from the classical library to output a total exchange-correlation energy, allowing an update and convergence check module to iteratively refine the electron density and evaluate ground-state stabilization. This can produce a highly accurate and physically robust molecular simulation while also bypassing the need for exponential data augmentation and training overhead, thereby enhancing computational efficiency and overall predictive reliability.

Another object of the present disclosure is to provide a method for controlling an artificial intelligence (AI) device that can include generating, by a processor in the AI device, a real-space electron density for a target system, encoding a representation of the real-space electron density into a multi-qubit quantum state, processing the multi-qubit quantum state using a parameterized quantum circuit, wherein the parameterized quantum circuit includes a quantum neural network configured to be equivariant to an orthogonal group O(3) or finite subgroups of the orthogonal group O(3), measuring an output of the parameterized quantum circuit to obtain spatial weighting coefficients, calculating an exchange-correlation (XC) energy contribution by combining the spatial weighting coefficients with one or more analytical primitive energy-density terms and outputting the exchange-correlation (XC) energy contribution.

It is another object of the present disclosure to provide a method that can further include updating the real-space electron density for the target system based on Kohn-Sham equations of a density functional theory (DFT) calculation using the XC energy contribution, iterating the generating the real-space electron density, the encoding the representation of the real-space electron density, the processing the multi-qubit quantum state, the measuring the output of the parameterized quantum circuit, the calculating the exchange-correlation (XC) energy contribution, and the updating the real-space electron density within a self-consistent field (SCF) loop until a convergence criterion for a ground-state energy and an electron density is satisfied based on at least one condition, and in response to the convergence criterion being satisfied based on the at least one condition, outputting converged ground-state data.

Yet another object of the present disclosure is to provide a method, in which the updating the real-space electron density includes utilizing a newly calculated Kohn-Sham potential comprising an exchange-correlation potential as a functional derivative of a Kohn-Sham total energy to generate a new charge density and an estimate of the Kohn-Sham total energy.

An object of the present disclosure is to provide a method, in which the at least one condition for the convergence criterion includes at least one of a change in the ground-state energy between successive iterations of the SCF loop falling below a first predefined threshold, a change in the electron density between successive iterations of the SCF loop falling below a second predefined threshold, or a change in a Kohn-Sham potential between successive iterations of the SCF loop falling below a third predefined threshold.

Another object of the present disclosure is to provide a method that further includes executing, by the AI device, an automated testing or screening action for a chemical reaction, a compound filtering, or a molecular dissociation simulation based on the converged ground-state data.

An object of the present disclosure is to provide a method, in which the generating the real-space electron density and the calculating the XC energy contribution are performed by a classical computing subsystem of the AI device, and the encoding the representation, the processing the multi-qubit quantum state, and the measuring the output are performed by a quantum computing subsystem of the AI device.

Another object of the present disclosure is to provide a method, in which the parameterized quantum circuit includes symmetry-twirled gates configured to project quantum operations into a symmetry-invariant subspace by averaging a base quantum operator across possible symmetry transformations in the orthogonal group O(3) or the finite subgroups of the orthogonal group O(3).

Yet another object of the present disclosure is to provide a method, in which the encoding the representation of the real-space electron density into the multi-qubit quantum state includes mapping classical density grid data into the multi-qubit quantum state utilizing an encoding module configured to perform at least one of amplitude embedding, basis embedding, angle encoding, rotation encoding, Hamiltonian embedding, squeezing embedding, or displacement embedding.

An object of the present disclosure is to provide a method that further includes downsampling, prior to the encoding, the real-space electron density on a three-dimensional grid to generate a reduced-length vector of density-derived input features, in which the representation of the real-space electron density encoded into the multi-qubit quantum state includes the reduced-length vector.

Another object of the present disclosure is to provide a method, in which the one or more analytical primitive energy-density terms include a Local Density Approximation (LDA) baseline evaluated by the processor, and the calculating the XC energy contribution includes multiplying the spatial weighting coefficients by the analytical primitive energy-density terms at respective grid points and integrating over a three-dimensional spatial grid.

An object of the present disclosure is to provide a method, in which the target system includes a molecule or a periodic solid, and the method further includes evaluating classical components of a total energy for the target system based on the real-space electron density, the classical components including a Kohn-Sham kinetic energy, an external energy from electron-nuclei interactions, and a Hartree energy.

Another object of the present disclosure is to provide an artificial intelligence (AI) device including a memory configured to store information for a target system, and a controller configured to generate a real-space electron density for the target system, encode a representation of the real-space electron density into a multi-qubit quantum state, process the multi-qubit quantum state using a parameterized quantum circuit, wherein the parameterized quantum circuit includes a quantum neural network configured to be equivariant to an orthogonal group O(3) or finite subgroups of the orthogonal group O(3), measure an output of the parameterized quantum circuit to obtain spatial weighting coefficients, calculate an exchange-correlation (XC) energy contribution by combining the spatial weighting coefficients with one or more analytical primitive energy-density terms, and output the exchange-correlation (XC) energy contribution.

An object of the present disclosure is to provide a non-transitory computer readable medium storing computer-executable instructions that when executed by a processor, cause the processor to perform the operations of generating an initial real-space electron density for a target system, encoding a representation of the real-space electron density into a multi-qubit quantum state, processing the multi-qubit quantum state using a parameterized quantum circuit, in which the parameterized quantum circuit includes a quantum neural network configured to be equivariant to an orthogonal group O(3) or finite subgroups of the orthogonal group O(3), measuring an output of the parameterized quantum circuit to obtain spatial weighting coefficients, calculating an exchange-correlation (XC) energy contribution by combining the spatial weighting coefficients with one or more analytical primitive energy-density terms, and outputting the exchange-correlation (XC) energy contribution.

Another object of the present disclosure is to provide a hybrid quantum-classical computing system for calculating ground-state electronic properties of a target using density functional theory (DFT), the hybrid quantum-classical computing system including a classical computing subsystem comprising at least one classical processor and a memory storing a classical DFT engine and a library of energy-density primitives, a quantum computing subsystem in communication with the classical computing subsystem, the quantum computing subsystem comprising a quantum processor having a plurality of qubits, in which the classical computing subsystem and the quantum computing subsystem are collectively configured to execute a self-consistent field (SCF) loop by executing, via the classical processor, the classical DFT engine to generate an initial real-space electron density for the target and calculate a Kohn-Sham kinetic energy, an external energy from electron-nuclei interactions, and a Hartree energy, transmitting, from the classical computing subsystem to the quantum computing subsystem, encoded data representing the initial real-space electron density, preparing, on the quantum processor, a multi-qubit quantum state based on the encoded data, processing the multi-qubit quantum state on the quantum processor using a parameterized quantum circuit, wherein the parameterized quantum circuit comprises a quantum neural network configured to be explicitly equivariant to an orthogonal group O(3) or finite subgroups of the orthogonal group O(3), measuring an output of the parameterized quantum circuit to obtain a set of spatial weighting coefficients and transmitting the set of spatial weighting coefficients back to the classical computing subsystem, calculating, via the classical processor, an exchange-correlation (XC) energy contribution by combining the set of spatial weighting coefficients with the energy-density primitives, and updating, via the classical DFT engine, Kohn-Sham equations using the XC energy contribution to generate an updated real-space electron density until a convergence criterion is satisfied, and whereupon the classical computing subsystem can be configured to output converged ground-state data.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an example of a hybrid quantum-classical computer architecture according to an embodiment of the present disclosure.

FIG. 4 illustrates an example block diagram of a hybrid quantum-classical computing device including classical and quantum computing subsystems according to an embodiment of the present disclosure.

FIG. 5 illustrates an example flow chart for a method of controlling an AI device according to an embodiment of the present disclosure.

FIG. 6 illustrates an example workflow comparing classical, naive quantum, and group-invariant quantum neural network architectures for calculating total molecular energy according to an embodiment of the present disclosure.

FIG. 7 illustrates an example data processing flow demonstrating group transformations for a group-equivariant quantum neural functional according to an embodiment of the present disclosure.

FIG. 8 illustrates an example diagram detailing coefficient equivariance in a quantum circuit utilizing symmetry-twirled gates according to an embodiment of the present disclosure.

FIG. 9 illustrates an graph comparing the performance for simulating molecular dissociation using a classical neural network, a naive quantum neural network, and a group-invariant quantum neural network according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through the following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Also, the term device used herein can refer to a single device or a group of multiple devices that are connected together via wired connections or wireless connections.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Quantum computing is a field of computing that utilizes the principles of quantum mechanics to process and store information. At its core are quantum bits, or qubits, which can exist in multiple states simultaneously due to superposition. Unlike classical bits, which are either 0 or 1, qubits can represent 0, 1, or any combination of both at the same time. This property allows quantum computers to perform many calculations simultaneously, potentially solving complex problems exponentially faster than classical computers.

Also, quantum computing can take advantage of any two state system, e.g., qubits can be based on the spin of an electron, photon polarization, superconducting circuits, nuclear spin, trapped ions, defects in diamond crystals, etc. Quantum computing also involves entanglement, where the states of qubits are interconnected and offer powerful computation capabilities (e.g., computations can scale exponentially by 2ⁿ where n is the number of qubits).

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

In addition, a hybrid quantum-classical computer architecture can incorporate a neural network by combining the strengths of both classical and quantum computers to solve complex problems. The quantum component of the architecture can include qubits, which are employed to execute specific quantum computations suited for tasks like quantum simulations, optimization, or solving quantum chemistry problems or material discovery (e.g., a QPU). Also, the classical part of the architecture can include one or more CPU's and/or GPU's that can handle tasks that are not well suited for quantum processing, such as managing the overall computation, handling input and output, and running classical algorithms. Further, a neural network can be used to translate data and tasks between the CPU (e.g., and/or a GPU) and the QPU, and for optimizing the system, solving for parameters and adjusting parameters (e.g., minimizing a cost function).

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which can be implemented as a deep neural network (DNN) including a plurality of hidden layers among artificial neural networks, is also referred to as deep learning, and the deep learning is part of machine learning. In the following, machine learning is used to mean deep learning.

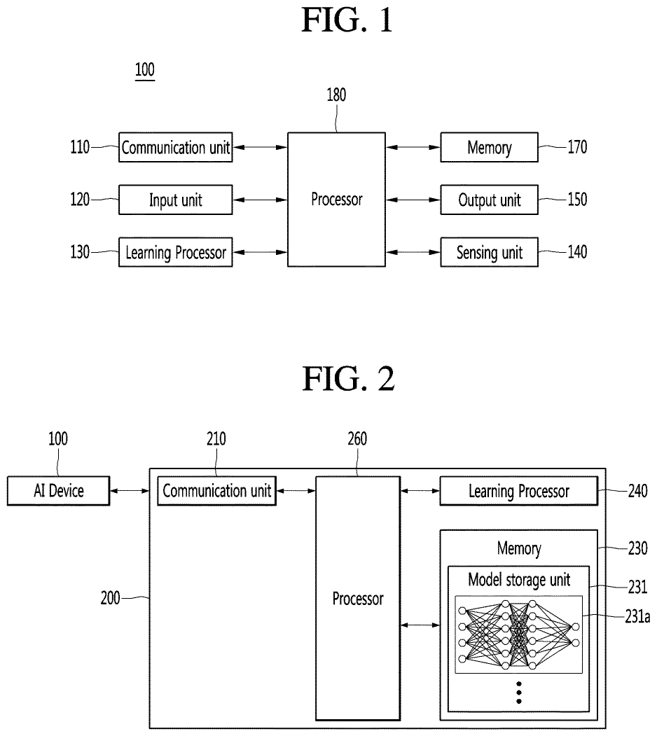

FIG. 1 illustrates an artificial intelligence (AI) device 100 which can be used as part of a hybrid quantum-classical computer architecture (e.g., the classical part), according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

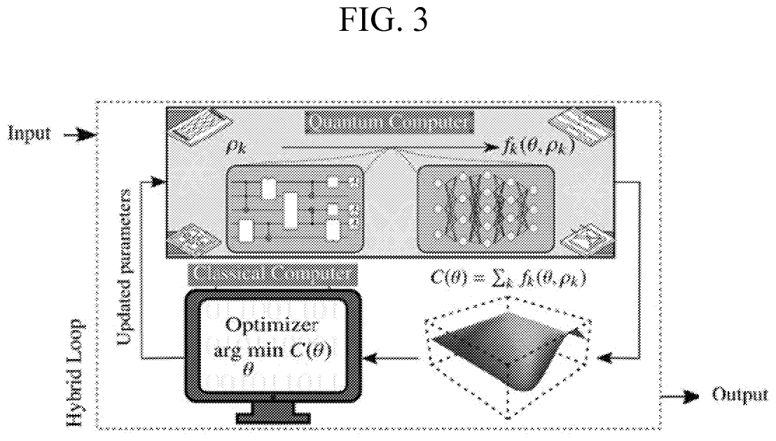

The communication unit 110 (e.g., communication interface or transceiver) can transmit and receive data to and from external devices such as other AI devices 100a to 100e and the AI server 200 (e.g., FIGS. 2 and 3) by using wire/wireless communication technology. For example, the communication unit 110 can transmit and receive sensor information, a user input, a learning model, and a control signal to and from external devices.

The communication technology used by the communication unit 110 can include GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data. For example, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using a learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to infer a result value for new input data rather than learning data, and the inferred value can be used as a basis for determination to perform a certain operation.

For example, the learning processor 130 can perform AI processing together with the learning processor 240 of the AI server 200.

In addition, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

In addition, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a data analysis algorithm or a machine learning algorithm. The processor 180 can control the components of the AI device 100 to execute the determined operation. For example, the processor 180 can evaluate logic rules for solving for or finding parameters that are fed into a quantum circuit (e.g., rotation angles for quantum gates, etc.).

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is required to perform the determined operation, the processor 180 can generate a control signal for controlling the external device and can transmit the generated control signal to the external device.

The processor 180 can acquire information for the user input and can determine an answer or a recommended item or action based on the acquired intention information.

The processor 180 can acquire the information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server 200 according to one embodiment. The AI server can implement one or more components or tasks related to the classical computing portion in the hybrid quantum-classical computer architecture.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. Also, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The learning model can be implemented in hardware, software, or a combination of hardware and software. If all or part of the learning models are implemented in software, one or more instructions that constitute the learning model can be stored in the memory 230.

The processor 260 can infer the result value for new input data by using the learning model and can generate a response or a control command based on the inferred result value.

FIG. 3 illustrates an example of a hybrid quantum-classical computer architecture according to an embodiment of the present disclosure.

The hybrid quantum-classical computer architecture can include a quantum processing unit (QPU) and a classical processing unit (CPU, or GPU, etc.) interfaced to leverage the advantages of quantum and classical computing. The QPU includes qubits capable of superposition and entanglement for executing quantum algorithms and operations to tackle complex multi-electron problems.

For example, the qubits can represent multiple states simultaneously due to superposition, enabling advanced quantum simulations and the evaluation of complex, classically intractable mathematical formulations.

In addition, the CPU and/or GPU can manage classical computations, such as executing classical density functional theory (DFT) engines, data input/output, and overall system control. An interface layer can be included which facilitates communication between the quantum and classical components, such as translating classical electron density data into multi-qubit quantum states and translating quantum measurements back into classical values. This layer includes software, firmware and protocols for carrying out tasks, optimizing performance, encoding features and managing the hybrid system.

Quantum algorithms are run on the QPU to exploit quantum properties such as superposition and entanglement. These algorithms, such as parameterized quantum circuits configured as quantum neural functionals (QNFs), can outperform classical counterparts in specific tasks like resolving exchange-correlation energies. Also, control software operating on the CPU can oversee the hybrid system's operation, including managing self-consistent field (SCF) loops, noise mitigation, and optimization routines used for the quantum computation.

In addition, algorithmic error correction and spatial mitigation techniques, such as symmetry-twirling operations, can be integrated into the architecture to address inherent noise, hardware biases, and non-physical symmetry violations in the quantum hardware. The hybrid architecture can also include an application layer for user interface software, enabling interaction with the system for inputting molecular geometries, receiving simulation results, and analyzing data.

In more detail, the classical computer can include an optimizer or optimization function, which can implement a cost function or objective function. The cost function can be related to minimizing total molecular energy or optimizing an exchange-correlation functional, and can be optimized using various techniques, such as gradient descent, but embodiments are not limited thereto. Also, the optimizer can use various hyperparameters, such as determining how many iterations to use and how big the steps should be for use in a descent for converging on a minimum energy state.

The hybrid quantum-classical computer architecture can be referred to as a near-term quantum computer, a noisy intermediate scale quantum (NISQ) computer, or a NISQ device. By utilizing group-equivariant architectures, the required quantum gate depth and training data overhead can be significantly reduced, making the system highly suitable for NISQ hardware constraints.

Also, optimization problems often arise in computational chemistry, physics and material science. The problem of finding the ground state of a molecular system is one such problem which can be cast as an optimization problem. Hybrid quantum-classical loops, such as variational algorithms and quantum neural functionals, can be utilized to address this problem. These architectures can use noisy quantum computers and classical DFT solvers to solve such optimization problems and gain near-term quantum advantage.

Also, various operations can be applied to the qubits in the quantum computer. For example, the operations can include rotations around certain axes (e.g., RY gates for qubit rotations), entanglement operations, and symmetry-twirled composite gates designed to forcefully project the quantum state into a specific symmetric subspace (e.g., the O(3) group).

In addition, based on the measurements and a given cost function, the classical computer can solve for various parameters and apply updates to the quantum gates and the classical electron density grid. In other words, the guess for finding the ground-state electron density can be effectively refined. This can be repeated as a type of optimization loop (e.g., an SCF loop) such that the system gradually converges to the true ground state.

According to embodiments, the classical computer can use an artificial intelligence (AI) model (e.g., a classical neural network) or analytical evaluators to solve for parameters of the quantum circuit and assemble the final exchange-correlation energy, but embodiments are not limited thereto.

Also, the system can determine whether the electron density converges to a desired state (e.g., stabilization of the ground state energy within a threshold). If convergence is not reached, then the process repeats, the electron density is updated, new parameters (e.g., rotation angles) are fed into the quantum hardware, and the quantum circuit is run again. The process can iterate until convergence is reached and the output is a final result.

For example, a final result can be the calculated exact ground-state energy and structural properties of the molecular system. This is highly useful for a wide range of simulations across various fields, such as quantum chemistry and material science.

For instance, calculating accurate ground states of highly correlated molecules provides insights into their electronic structures, bond energies, and reaction mechanisms, which can be directly used for drug discovery and developing new materials.

To fully appreciate the technical advantages of the disclosed method and hybrid quantum-classical architecture, it is helpful to first understand some foundational principles of quantum computing and the specific computational bottlenecks inherent in traditional molecular simulations.

In the early 1980s, physicist Richard Feynman famously observed that nature is not classical, and if one wishes to simulate nature accurately, one must use a quantum mechanical computer. Traditional classical computers operate using binary bits, which represent information as either a 0 or a 1. While classical computers are incredibly powerful, their binary nature makes it exponentially difficult to simulate the complex, overlapping probabilities inherent in quantum mechanics, e.g., such as the behavior of electrons in a molecule.

Quantum computers solve this by utilizing quantum bits, or qubits. Unlike classical bits, qubits can exist in a state of superposition, meaning they can represent 0, 1, or any combination of both simultaneously. Furthermore, qubits can be linked through entanglement, where the state of one qubit is directly connected to the state of another, regardless of physical distance. These properties can allow quantum computers to process massive amounts of complex, interrelated variables simultaneously, which offers exponential speed-ups for specific multi-body physics problems.

In computational chemistry, one of the most important goals is to determine the ground-state energy of a molecule or material. This means finding the absolute lowest-energy arrangement of electrons around the nuclei.

In a many-electron quantum problem, this is exceptionally difficult because all the electrons actively interact with and repel one another. To find the exact answer, scientists traditionally must compute the system's wavefunction. However, as a molecule gets larger and more electrons are added, calculating the exact wavefunction becomes exponentially expensive and ultimately impossible for classical computers to solve.

To bypass the impossible task of calculating the full wavefunction, physicists developed Density Functional Theory (DFT). DFT simplifies the problem by fundamentally changing the main quantity being solved for. For instance, instead of directly solving for the full many-electron wavefunction, DFT works with the electron density, which is a function that simply maps out how much electronic charge is present at each specific point in 3D space.

The key theoretical breakthrough of DFT is that, in principle, all ground-state properties of a molecule are entirely determined by this electron density.

In practical applications, such as Kohn-Sham DFT, the classical computer starts with an educated guess for the electron density. Using that initial density, the computer evaluates the classical components of the total energy, such as the Kohn-Sham kinetic energy, the external energy (usually from electron-nuclei interactions), and the Hartree energy.

For instance, the total ground-state energy of a molecular system can be mathematically expressed using the Kohn-Sham (KS) DFT framework. According to an embodiment, the classical Kohn-Sham total energy E_{KS} [ρ] can be defined by Equation 1, below.

$$[ Equation 1 ]$$

$${E}_{K S} [ ρ ] := {\sum }_{i = 1}^{N} \int dr {\vert ∇ {φ}_{i} ( r ) \vert}^{2} + \int d r {v}_{e x t} ( r ) ρ ( r ) + \frac{1}{2} \int dr {dr}^{′} \frac{ρ ( r ) ρ ( {r}^{′} )}{\vert r - {r}^{′} \vert} + {E}_{II} + {E}_{XC} [ ρ ]$$

In Equation 1, the total energy is calculated based on the electron density ρ(r). The first term represents the Kohn-Sham kinetic energy of the non-interacting electrons. The second term represents the external energy, which typically accounts for the electron-nuclei interactions. The third term represents the Hartree energy, which describes the classical electron-electron coulomb repulsion. The fourth term E_{II} represents the static ion-ion interaction energy. Finally, the last term E_{XC}[ρ] represents the exchange-correlation energy, which accounts for the complex quantum many-body effects.

However, the exchange-correlation (XC) term presents a type of bottleneck issue. For example, the classical computer then solves these effective one-electron equations to obtain a new set of electron orbitals, from which it builds a new, updated electron density. If the new density does not match the old density, the process repeats.

This repeating process is called the self-consistent field (SCF) loop. To prevent numerical instabilities during this repetition, classical DFT workflows can utilize charge density mixing to blend the newly predicted charge density with the previous charge density before the next cycle. The SCF loop continues looping and mixing until the density and the energy stop changing meaningfully from one iteration to the next. At that point, the calculation is said to have converged, and the resulting energy is output as the DFT estimate of the ground-state energy.

However, a major problem exists within this loop, which is the exchange-correlation (XC) term.

The reason this XC term is the ultimate bottleneck of traditional DFT is that it represents the incredibly complicated many-body quantum effects that are not captured by the simpler kinetic or repulsive pieces. Because the exact mathematical form of the XC term is unknown, traditional DFT workflows use hand-designed, classical approximations (such as Local Density Approximations (LDA)).

These classical approximations are computationally efficient, but they struggle and produce highly inaccurate results when simulating molecules where electron correlation is strong or highly nonlocal. For example, strong electron correlation occurs when a chemical bond is stretched to its breaking point and the electrons must intricately avoid one another. Also, highly nonlocal interactions occur when separate molecules influence each other across relatively large spatial distances, such as in long-range Van der Waals forces.

To solve this problem, some researchers have attempted to replace these classical approximations with trained machine learning models and quantum neural networks designed to learn the XC term.

However, a generic quantum neural network faces a critical failure. For instance, it lacks an inherent understanding of physical space. If you rotate a molecule 90 degrees in a 3D simulation, a generic network might calculate a completely different total energy, which violates the fundamental laws of physics.

This requires asking a critical question of how do we force a quantum computer to inherently understand that a molecule's energy does not change just because its orientation changes?

According to embodiments and explained in more detail below, the answer lies in strict mathematical symmetry, such as group theory. It is not enough for a network to be generally “equivariant” (predictable), it should be group-equivariant. The term “group” refers to formal mathematical symmetry groups, such as the O(3) group, which contains all possible 3D rotations and reflections. By designing a quantum neural functional that is mathematically bound to the O(3) group, the system is guaranteed to respect physical spatial symmetries.

For example, with regards to the O(3) group, “O” (orthogonal) means the transformation preserves lengths and angles. If you move a molecule, the distance between its atoms does not stretch or shrink. Also, the “3” refers to standard three-dimensional space (x, y, z axes).

In other words, the O(3) group, or orthogonal group in dimension 3, is the mathematical set that describes all possible continuous rotations and reflections of an object in three-dimensional space while preserving its internal distances and angles. By designing a quantum neural functional that is mathematically bound to the O(3) group, the system is guaranteed to respect physical spatial symmetries.

To physically execute this on noisy quantum hardware, the disclosed method and framework can utilize symmetry-twirled gates, according to an embodiment. A symmetry-twirled gate is a composite quantum operation that forcefully projects a base quantum gate into a specific symmetric subspace by sandwiching it between random symmetry transformations and their exact inverses, then averaging the results. This cancels out asymmetric behavior, hardware noise and spatial biases.

Accordingly, various embodiments of the present disclosure can enhance traditional DFT frameworks. For example, while iterative processes such as a classical SCF loop can be utilized, the determination of complex many-body effects like the exchange-correlation contribution can be supplemented or replaced by a quantum neural functional, according to an embodiment.

By implementing architectures that can incorporate group-equivariant properties or symmetry-twirled operations, the disclosed system can achieve enhanced quantum-level accuracy while promoting the physical consistency desired for robust chemical, material and biological simulations.

According to an embodiment, the AI device 100 can provide a group-equivariant quantum neural functional framework that overcomes the limitations of prior approaches. For example, a multi-component hybrid framework can be employed that utilizes both classical and quantum computing models, in which different components are configured to perform specialized tasks. The framework can include a classical density functional theory (DFT) engine to generate an electron density grid and primitive energy terms, a group-equivariant quantum neural functional module to evaluate complex exchange-correlation contributions based on fundamental physical symmetries, and an update and convergence check module to iteratively refine the ground-state energy by integrating the quantum-derived weights into the classical loop, thereby ensuring a highly accurate and physically consistent molecular simulation.

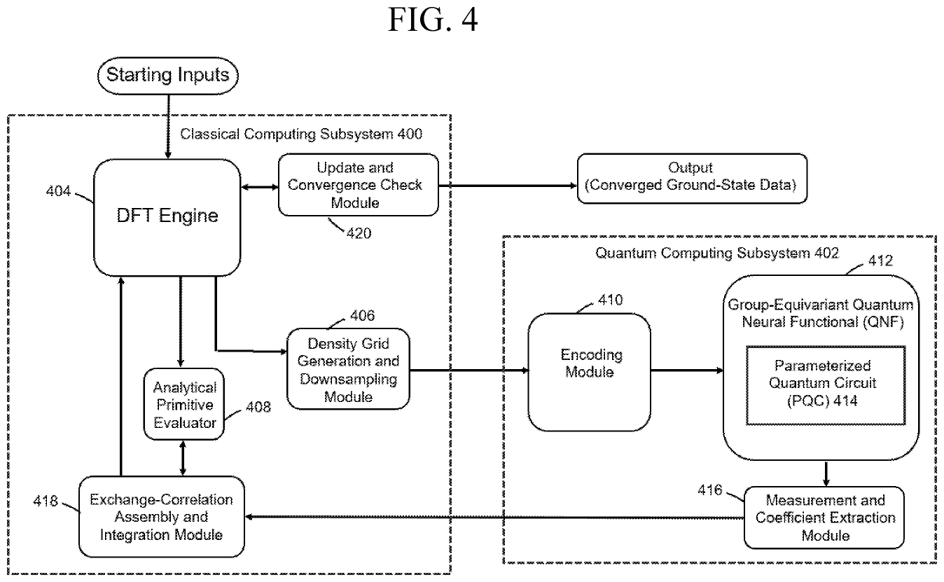

FIG. 4 illustrates a block diagram of an example of a hybrid quantum-classical computing device including classical and quantum computing subsystems, according to an embodiment of the present disclosure.

For example, according to an embodiment, the framework can be implemented as a cohesive architecture of interconnected modules designed to implement an iterative self-consistent field (SCF) loop for evaluating the ground-state energy of a chemical, material, or biological system at a given atomic configuration.

As shown in FIG. 4, the framework can include two main modules or two main parts, in which the first module can be referred to as a classical computing subsystem 400 and the second module can be referred to as a quantum computing subsystem 402.

The classical computing subsystem 400 can include a density functional theory (DFT) engine 404, a density grid generation and downsampling module 406, an analytical primitive evaluator 408, an exchange-correlation assembly and integration module 418, and an update and convergence check module 420. For example, the classical computing subsystem 400 can include classical hardware (CPU, and/or GPU, memory, storage) that oversees the entire simulation, manages the classical data arrays, and runs the overarching loops.

The quantum computing subsystem 402 can include an encoding module 410, a group-equivariant quantum neural functional (QNF) 412, a parameterized quantum circuit (PQC) 414, and a measurement and coefficient extraction module 416. For example, the quantum computing subsystem 402 can include gate-model quantum hardware (QPU and qubits).

According to an embodiment, the framework can begin processing at the DFT engine 404, which can be configured as a classical processor executing Kohn-Sham DFT programs. However, embodiments are not limited thereto. According to an embodiment, the classical processor can execute various other computational chemistry, solid-state physics, or materials science frameworks.

The DFT engine 404 can receive a starting physical input, such as a molecular or material system definition. For example, the starting input can include atomic species, nuclear positions, a total number of electrons, spin settings, basis/grid settings, and an initial guess for the electron density defined on a three-dimensional grid.

Internally, the DFT engine 404 can operate by forming the effective one-electron terms of the problem, such as kinetic-energy and external-potential contributions, based on the starting input. As a result of this initialization process, the DFT engine 404 can calculate and output an initial real-space electron density defined on a computational grid.

Following the generation of the initial electron density, the density grid generation and downsampling module 406 can receive the current real-space electron density as an input. According to an embodiment, the density grid generation and downsampling module 406 can operate using deterministic math and programming logic to sample the density on a grid covering a region of interest.

For example, to accommodate near-term or limited-resource quantum hardware, the density grid generation and downsampling module 406 can function as a compression engine that downsamples the grid to a smaller set of representative grid values, thereby reducing the dimension of the input vector so that it requires fewer qubits. Based on these geometric calculations, the density grid generation and downsampling module 406 can output a reduced-length vector of density-derived input features, such as a 512-component vector.

According to another embodiment, if ample quantum computational resources are available, the downsampling can be skipped and work can be performed directly with the charge density on the original finer grid.

In parallel or sequentially, the analytical primitive evaluator 408 can also receive the current electron density from the DFT engine 404 as an input. The analytical primitive evaluator 408 can function as a math engine that evaluates one or more primitive exchange and/or correlation energy-density terms using a known analytical form (e.g., Perdew-Wang local density approximation energy densities).

By processing these terms, the analytical primitive evaluator 408 can output a set of classical primitive energy-density values defined comprehensively across the grid, which provides a physically meaningful classical baseline for the model. For example, the learned model can reweight these values in a density-dependent way. Also, one or more primitives can be used according to embodiments and design considerations.

Next, processing can shift to the quantum computing subsystem 402, where the encoding module 410 can receive the downsampled density-derived vector as an input. The encoding module 410 can act as a classical-to-quantum interface. Internally, the encoding module 410 can arrange the classical input values into a fixed order, normalize them to form a valid quantum state, and apply a state-preparation circuit that maps an all-zero input state to the encoded state.

As a result of this encoding process, the encoding module 410 can output a multi-qubit quantum state whose amplitudes physically represent the current density-derived input vector. For example, the amplitude encoding process can allow a classical vector of length 2ⁿ to be efficiently represented using n qubits on the quantum hardware, but embodiments are not limited thereto.

According to an embodiment, the encoding module 410 can utilize any suitable quantum embedding or state preparation technique to map the classical density grid data into a multi-qubit quantum state. Non-limiting examples of such encoding techniques include amplitude embedding, basis embedding, angle or rotation encoding, Hamiltonian embedding, squeezing embedding, or displacement embedding. Accordingly, the present disclosure is not limited to any one specific method or family of methods for translating classical feature vectors into a quantum representation, and any technique capable of embedding the charge density grid data into a quantum state can be utilized, according to embodiment and design considerations.

Further in this example, the group-equivariant QNF 412 can receive the encoded quantum state and fixed, pre-trained model parameters as inputs. The group-equivariant QNF 412 can be configured as a quantum-based deep learning module that utilizes a parameterized quantum circuit (PQC) 414 as a learned nonlinear model component to transform the input quantum state.

According to an embodiment, to guarantee physical consistency, the circuit structure of the PQC 414 can be configured to be group-equivariant by utilizing symmetry twirling under discrete subgroups of the rotational group. This model operates in three dimensions.

For example, according to an embodiment, the parameterized quantum circuit (PQC) can include the specific structural architecture of the quantum logic gates inside the QNF. The PQC 414 is configured to commute with physical symmetry operations (like 3D rotations or the orthogonal group O(3)), ensuring the network processes data consistently regardless of the molecule's or periodic solid's spatial orientation.

Furthermore, the parameterized quantum circuit can include a quantum neural network, in which the quantum neural network can be configured to be explicitly equivariant to the orthogonal group O(3) or the finite subgroups of O(3). Because the classical charge density is practically evaluated and represented on a regular three-dimensional spatial grid, arbitrary continuous rotations may not be perfectly mapped across the discrete points. Therefore, the quantum neural network can be advantageously configured to be equivariant to the finite subgroups of O(3) that are commensurate with the specific geometric structure of the underlying computational grid, thereby ensuring perfect mathematical consistency without requiring interpolation.

Accordingly, transforming the input density by a spatial symmetry operation produces a correspondingly structured transformation in the circuit output. Through this symmetry-aware transformation, the group-equivariant QNF 412 can output a processed, symmetry-aware quantum state that encodes learned information regarding how to precisely weight the exchange-correlation energy-density contributions.

For example, the output of the group-equivariant QNF 412 is a processed quantum state that encodes learned information about how to weight exchange-correlation energy-density contributions.

Following the quantum transformation, the measurement and coefficient extraction module 416 can receive the processed quantum state as an input. The measurement and coefficient extraction module 416 can measure the quantum state utilizing basis-state projectors, in which the probability of observing certain computational basis outcomes is used to define spatial coefficients. Based on these quantum measurements, the measurement and coefficient extraction module 416 can generate and output a set of learned spatial weighting coefficient values defined over the spatial grid.

Next, the framework can return to the classical computing subsystem 400, where the exchange-correlation assembly and integration module 418 can receive the primitive energy-density terms from the analytical primitive evaluator 408 and the learned spatial weighting coefficients from the measurement and coefficient extraction module 416 as inputs.

Internally, the exchange-correlation assembly and integration module 418 can multiply the learned coefficient values by the primitive energy-density values at each respective grid point. These weighted terms are then summed and integrated over space, e.g., to produce the total exchange-correlation energy contribution. As a result of this integration process, the exchange-correlation assembly and integration module 418 can output a total exchange-correlation energy contribution.

To formalize this operation, the trainable exchange-correlation energy

$${E}_{XC}^{θ} [ ρ ]$$

evaluated by the assembly and integration module 418 can be defined by the following Equation 2.

$${E}_{X C}^{θ} [ ρ ] := \int dr {\sum }_{k} {c}_{k}^{θ} [ ρ ] ( r ) {ϵ}_{k} [ ρ ] ( r ) \qquad [ Equation 2 ]$$

In this trainable equation, ∈ₖ [ρ](r) represents a set of classical primitive energy-density terms evaluated by the classical computing subsystem (e.g., utilizing a Perdew-Wang (PW) local density approximation (LDA) or similar baseline). The term

$${c}_{k}^{θ} [ ρ ] ( r )$$

represents the spatial weighting coefficients output by the parameterized quantum circuit (PQC), where θ denotes the trainable parameters of the quantum network (e.g., the rotation angles of the quantum gates). According to an embodiment, by multiplying these learned, symmetry-aware quantum coefficients by the classical primitive terms and integrating the result over the three-dimensional spatial grid, the exchange-correlation assembly and integration module 418 can systematically assemble a highly accurate, group-equivariant exchange-correlation energy.

The DFT engine 404 can then receive this total exchange-correlation energy contribution to update the Kohn-Sham problem. Using this data, the DFT engine 404 can solve for updated orbitals, and produce an updated electron density and an updated total energy estimate.

Then, the update and convergence check module 420 can receive the updated electron density, potential, and total energy estimates as inputs. The update and convergence check module 420 evaluates whether the iterative SCF loop should terminate or repeat by checking one or more termination conditions.

For example, the update and convergence check module 420 can manage the simulation's iterative loop by using the newly calculated Kohn-Sham potential (including the exchange-correlation potential) as the functional derivative of the Kohn-Sham total energy to generate a new charge density and an estimate of the Kohn-Sham total energy. The update and convergence check module 420 can then evaluate if this new state has stabilized below predefined thresholds to either finalize the ground-state data or trigger another simulation cycle.

For example, the module can determine if the change in total energy or electron density between successive iterations falls below a predetermined threshold.

According to embodiments, other termination conditions can include the change in electron density falling below a threshold, or the change in Kohn-Sham potential falls below a threshold.

If the condition is not met, the updated density is routed back to the downsampling module and analytical evaluator, and the entire hybrid quantum-classical process repeats. Furthermore, the updated density can also be passed more generally back through the main DFT engine to recalculate all of the Kohn-Sham potential terms. It should be noted that in practice, simply feeding the raw newly predicted charge density directly into the next cycle can cause numerical instabilities. Therefore, according to an embodiment, the system can utilize charge density mixing. Using established mathematical methods, the system can mix the newly predicted charge density generated at the current iteration with the currently predicted charge density from the previous iteration. For example, following this mixing process, in each cycle, the mixed current density is re-sampled, re-downsampled, re-encoded into the quantum state, reprocessed by the pre-trained quantum circuit, and used to generate a new exchange-correlation contribution. The loop continues until a convergence condition is satisfied.

However, if the termination condition is satisfied, the update and convergence check module 420 can output the final, converged ground-state electron density and the converged ground-state total energy for the system.

This final output data can be used in various downstream tasks, such as automated material discovery, pharmaceutical drug interaction simulations, and complex molecular binding analysis.

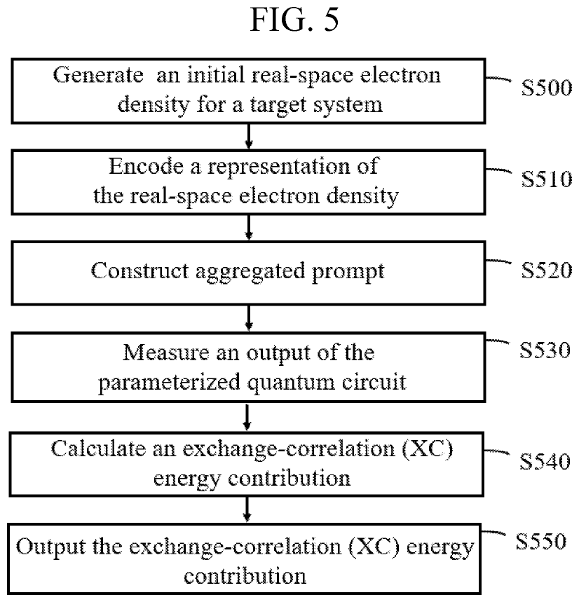

FIG. 5 shows an example flow chart of a method according to an embodiment of the present disclosure. For example, according to an embodiment, a method for controlling an AI device 100 can include generating, by a processor in the AI device 100, an initial real-space electron density for a target system (S500).

At step S510, the method can include encoding a representation of the real-space electron density into a multi-qubit quantum state. Following the encoding, at step S520, the method can include processing the multi-qubit quantum state using a parameterized quantum circuit (PQC), in which the parameterized quantum circuit includes a quantum neural network configured to be equivariant to an orthogonal group O(3) or finite subgroups of the orthogonal group O(3). By processing the data through this structurally symmetric circuit, the system can ensure physical consistency.

At step S530, the method can include measuring an output of the parameterized quantum circuit to obtain spatial weighting coefficients. Next, at step S540, the method can include calculating an exchange-correlation (XC) energy contribution by combining the spatial weighting coefficients with one or more analytical primitive energy-density terms.

Then, at step S550, the method can include outputting the exchange-correlation (XC) energy contribution.

Furthermore, according to an embodiment, the method can expand upon the base pipeline to execute a continuous optimization loop. For example, the method can further include updating the real-space electron density for the target system based on Kohn-Sham equations of a density functional theory (DFT) calculation using the XC energy contribution. During this updating process, the system can utilize charge density mixing to blend the newly predicted charge density with a current charge density to prevent numerical instabilities. The system can then iterate the generating, the encoding, the processing, the measuring, the calculating, and the updating within a self-consistent field (SCF) loop until a convergence criterion for a ground-state energy and an electron density is satisfied based on at least one condition. In response to the convergence criterion being satisfied based on the at least one condition, the method can include outputting converged ground-state data.

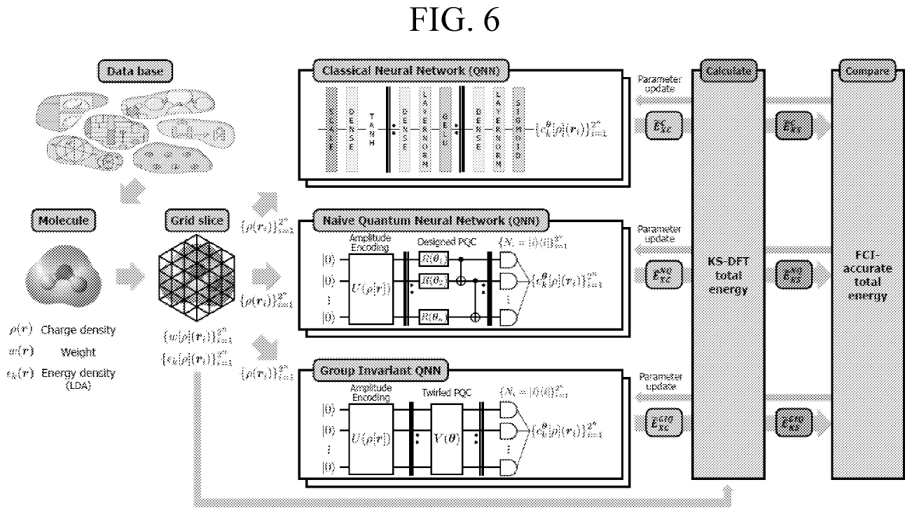

FIG. 6 illustrates an example workflow comparing classical, naive quantum, and group-invariant quantum neural network architectures for calculating total molecular energy according to an embodiment of the present disclosure.

As shown in FIG. 6, the workflow begins by extracting physical data from a database or a target molecule. For example, a classical processor can extract or calculate a charge density ρ(rᵢ), corresponding spatial weights w(r), and a classical energy density ∈ₖ(r) (such as from a Local Density Approximation (LDA)). The continuous charge density is then discretized into a 3D grid slice to form an input vector

$${\{ p ( {r}_{i} ) \}}_{i = 1}^{{2}^{n}}$$

that can be fed into three distinct neural network evaluation paths.

In FIG. 6, the upper path illustrates an example of a classical neural network (NN) workflow as a comparative example. In this classical path, the density grid input vector is passed through a sequence of traditional classical deep learning layers, such as scale, dense, tanh, layernorm, gelu, and sigmoid layers.

The classical NN outputs a set of spatial weighting coefficients

$${\{ {c}_{k}^{θ} [ ρ ] ( {r}_{i} ) \}}_{i = 1}^{{2}^{n}} ,$$

which are used to calculate a classical exchange-correlation energy [symbol] . This value is fed into the Kohn-Sham DFT (KS-DFT) loop to calculate a classical KS-DFT total energy [symbol] .

The middle path illustrates an example of a naive quantum neural network (QNN) workflow, according to an example embodiment. Here, the classical density grid input vector undergoes amplitude encoding to map the data into a multi-qubit quantum state |0 [symbol] →U(ρ[r]).

The quantum state is then processed by a generically designed parameterized quantum circuit (PQC) utilizing standard arbitrary rotation gates (e.g., R(θ₁), R(θₙ)) and entanglement gates. Following measurement via projectors

$${\{ N\_i = \vert i 〉 〈 i \vert \}}_{i = 1}^{{2}^{n}} ,$$

the naive QNN outputs its respective weighting coefficients to calculate a naive quantum exchange-correlation energy [symbol] and a corresponding naive KS-DFT total energy [symbol] . However, because the standard PQC lacks inherent spatial awareness, its outputs are physically inconsistent when the molecule's spatial orientation is altered.

To overcome the limitations of both the classical and naive quantum approaches, the bottom path illustrates a group-invariant QNN workflow according to an embodiment, which serves as a component of the disclosed hybrid architecture. The group-invariant QNN begins by receiving the density grid input vector

$${\{ ρ ( {r}_{i} ) \}}_{i = 1}^{{2}^{n}}$$

and utilizing an amplitude encoding block U(ρ[r]) to transfer the classical density information into a highly efficient quantum representation.

However, rather than passing the encoded state into a generically designed circuit, the group-invariant QNN processes the quantum state through a Twirled PQC, denoted as V(θ).

According to an embodiment, the Twirled PQC is fundamentally distinct from standard quantum circuits because it is mathematically constrained to respect physical symmetries. By implementing symmetry-twirled gates, the Twirled PQC can forcefully project the quantum operations into a symmetry-invariant subspace (such as the O(3) group). This internal mathematical structure ensures that if the input density ρ(r) is transformed by a 3D spatial rotation or reflection, the internal transformations within V(θ) remain perfectly consistent and physically valid.

Following processing by the Twirled PQC, the quantum state is measured using a set of basis-state projectors Ni. This measurement extracts the group-invariant spatial weighting coefficients

$${\{ {c}_{k}^{θ} [ ρ ] ( {r}_{i} ) \}}_{i = 1}^{{2}^{n}} .$$

Because the Twirled PQC inherently respects physical geometry, these extracted coefficients flawlessly map to the true physical orientation of the underlying molecule without requiring massive amounts of augmented rotational training data.

The learned group-invariant coefficients are then multiplied by the classical baseline energy density ∈ₖ(r) and integrated to calculate a highly accurate, group-invariant exchange-correlation energy [symbol] . As shown in the Calculate block, this mathematically robust XC energy is fed into the KS-DFT engine to compute the final group-invariant KS-DFT total energy [symbol] .

Then, as illustrated in the Compare block, the calculated total energy can be quantitatively evaluated against a highly accurate baseline, such as a full configuration interaction (FCI) accurate total energy. By calculating the loss or variance between the group-invariant estimation [symbol] and the true FCI—accurate total energy, the classical optimizer can accurately determine the necessary parameter updates.

These parameter updates (e.g., the θ rotation angles) can then be continuously fed back into the Twirled PQC in a closed optimization loop until the system reaches convergence, thereby yielding a ground-state molecular simulation that achieves quantum-level accuracy while guaranteeing strict physical symmetry.

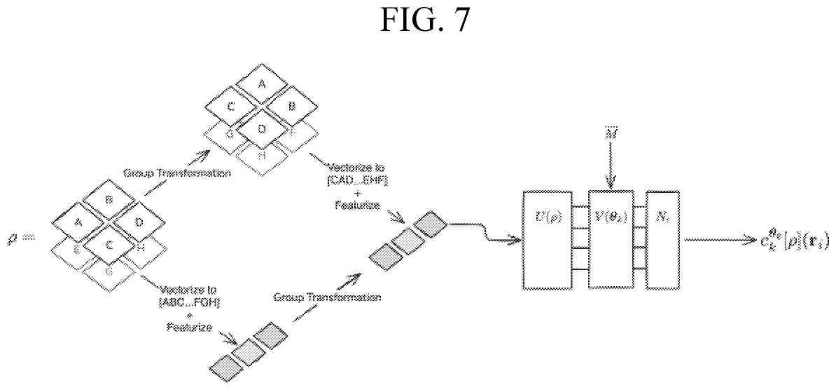

FIG. 7 illustrates an example data processing flow demonstrating group transformations for a group-equivariant quantum neural functional according to an embodiment of the present disclosure.

As shown on the left side of FIG. 7, the flow visually highlights the fundamental concept of equivariance with respect to an input electron density ρ. For example, the input density ρ can be conceptualized as a discrete 3D grid of spatial blocks or voxels (e.g., designated as blocks A through H).

For example, FIG. 7 illustrates two distinct processing paths that ultimately yield an identically structured feature representation.

In a first path (upper), a physical group transformation (such as a 3D spatial rotation) is directly applied to the 3D grid, reordering the physical blocks into a new geometric arrangement (e.g., [CAD . . . EHF]), which is subsequently vectorized and featurized.

In a second path (lower), the original grid is first vectorized into an initial baseline sequence (e.g., [ABC . . . FGH]) and featurized, and then the group transformation is applied mathematically to the resulting feature vector.

Further in this example, because the architecture is mathematically constrained to be group-equivariant, both processing paths reliably converge to the exact same transformed feature state. This ensures that the system's internal representation perfectly tracks physical spatial changes without introducing artificial errors or requiring redundant training.

Following the resolution of the group-equivariant feature vector, this structured data can be fed into the quantum processing pipeline, as shown on the right side of FIG. 7.

For example, the featurized density data is processed by the encoding module U(ρ) to map the classical data into a multi-qubit quantum state. This quantum state can then be processed by a parameterized quantum circuit V(θₖ).

Further, to ensure that the quantum circuit inherently respects the spatial symmetries demonstrated in the left-hand transformation, the circuit utilizes a group-twirling operation M̅ to forcefully project the quantum gates into a symmetric subspace. In other words, this can be viewed as a type of math technique that spins the computer's rules in every direction. This forces the computer to stop getting confused by upside-down or rotated shapes, ensuring it always knows the molecule is the exact same object no matter how it is turned or flipped around.

Then, the symmetrically transformed quantum state can be measured using basis-state projectors Nᵢ. As a result of this symmetry-aware processing, the circuit outputs a set of highly accurate, spatially consistent weighting coefficients

$${c}_{k}^{{θ}_{k}} [ ρ ] ( {r}_{i} ) .$$

These coefficients can subsequently be used by the classical host system to assemble the exact exchange-correlation energy regardless of how the initial molecule was physically rotated or oriented.

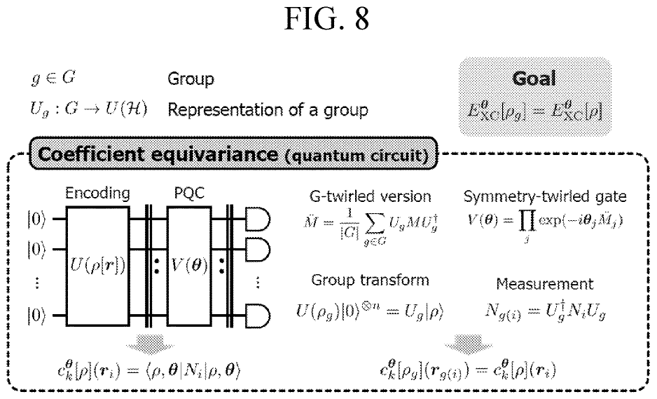

FIG. 8 illustrates an example diagram detailing coefficient equivariance in a quantum circuit utilizing symmetry-twirled gates according to an embodiment of the present disclosure.

As shown in the upper right portion of FIG. 8, an overarching goal of the group-equivariant architecture is to ensure that the calculated exchange-correlation energy remains perfectly invariant regardless of spatial transformations applied to the molecule. Mathematically, this goal is expressed as

$${E}_{XC}^{θ} [ {ρ}_{g} ] = {E}_{XC}^{θ} [ ρ ] ,$$

meaning that the total energy evaluated for a transformed electron density ρ_{g} is exactly equal to the energy evaluated for the original electron density ρ for any symmetry transformation g within the group G.

For example, the architecture can utilize a specially structured quantum circuit, as shown on the left side of the coefficient equivariance block. The circuit can begin by initializing a plurality of qubits into a base state |0>. These qubits are then passed through an amplitude encoding block U (ρ[r]), which maps the classical electron density distribution p into a highly entangled quantum state.

Following this amplitude encoding, the quantum state enters the parameterized quantum circuit (PQC), denoted as V(θ), which serves as an computational engine of the quantum neural functional.

As used herein, the term quantum neural functional (QNF) refers to a trainable quantum machine learning algorithm configured to map an input spatial function, such as an electron density field ρ(r), to a scalar physical property, such as a total exchange-correlation energy E_{XC}.

In a hybrid quantum-classical computing framework according to an embodiment, the QNF can use a parameterized quantum circuit (PQC) including trainable parameters (e.g., rotational gate angles) that are iteratively optimized to approximate the exact exchange-correlation functional of density functional theory (DFT).

While a generic QNF relies on standard quantum gates that lack inherent three-dimensional spatial awareness, the disclosed group-equivariant QNF improves upon this by utilizing symmetry-twirled gates. This structural constraint forcefully projects the quantum operations into a symmetry-invariant subspace, ensuring the quantum network inherently respects physical spatial symmetries and calculates a mathematically consistent total energy regardless of the target system's physical orientation.

In more detail, inside the PQC, standard arbitrary rotation gates are replaced with symmetry-twirled gates to forcefully inject physical symmetry into the quantum hardware. As detailed in the equations on the right side of FIG. 8, a base quantum operator M is transformed into a G-twirled version, denoted as M. This is achieved by taking the mathematical average of the operator across all possible symmetry transformations in the group, expressed as

$$\overline{M} = \frac{1}{\vert G \vert} {\sum }_{g ∈ G} {U}_{g} {MU}_{g}^{†} .$$

Then the PQC can construct its internal symmetry-twirled gates V(θ) by taking the product of the matrix exponentials of these twirled operators, expressed as V(θ)=Πⱼ exp(−IθM̅ⱼ).

With reference again to the PQC shown in FIG. 8, the symmetrically processed quantum state exits the PQC and is measured using a set of basis-state projectors Nᵢ. Because the PQC utilized the symmetry-twirled gates, the entire quantum circuit acts as an equivariant function.

Further in this example, as shown by the equations at the bottom of FIG. 8, measuring the circuit yields a set of spatial weighting coefficients

$${c}_{k}^{θ} [ ρ ] ( {r}_{i} ) .$$

For example, applying a group transformation g to the input density guarantees that the resulting coefficient at the transformed coordinate r_{g(i)} is mathematically identical to the original coefficient at the original coordinate rᵢ, expressed as

$${c}_{k}^{θ} [ {ρ}_{g} ] ( {r}_{g ( i )} ) = {c}_{k}^{θ} [ ρ ] ( {r}_{i} ) .$$

This coefficient equivariance ensures the classical host system receives physically robust, orientation-independent data to calculate the final exchange-correlation energy.

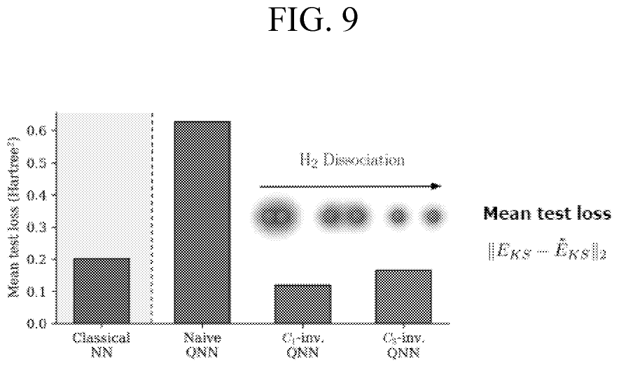

FIG. 9 illustrates an example bar chart demonstrating the experimental mean test loss of various neural network architectures when simulating molecular dissociation, according to embodiments of the present disclosure.

For example, the chart compares the performance of a classical neural network (Classical NN), a naive quantum neural network (Naive QNN), and two embodiments of the disclosed group-invariant quantum neural network (e.g., C₁-inv. QNN and C₃-inv. QNN) in evaluating the ground-state energy during the dissociation of a diatomic hydrogen molecule (H2).

As shown in FIG. 9, H₂ dissociation involves progressively increasing the distance between two hydrogen atoms. This is a notoriously difficult task for standard density functionals to simulate accurately because it requires precisely capturing complex electron correlation effects as the chemical bond stretches and ultimately breaks. The y-axis measures the mean test loss, which represents the mathematical variance or error ∥E_{KS}− [symbol] ∥₂ between the model's predicted total energy and a highly accurate baseline total energy. Therefore, a lower bar on the chart indicates higher predictive accuracy.

For context, “H₂ dissociation” is the physical process of progressively pulling two bonded hydrogen atoms apart until their chemical bond breaks. Simulating the exact energy required at each step of this stretching process is very difficult, allowing it to be a type of benchmark for molecular AI models.

To measure these incredibly small atomic forces, scientists use a unit called a Hartree. Similar to how a calorie measures energy in food, a Hartree is simply the standard unit of energy in quantum chemistry used to track the energy changes as the molecule separates. As demonstrated by the data, the present invention, according to embodiments, can provide significant technological advantages and improvements over prior approaches.

For instance, the classical NN provides a standard baseline level of accuracy. However, the naive QNN exhibits a massively increased error rate. Because the generically designed Naive QNN lacks internal spatial awareness, so it struggles to adapt to the changing spatial geometry of the dissociating molecule, resulting in physically inconsistent and highly inaccurate energy predictions.

In stark contrast to the CNN and the naive QNN, the disclosed group-invariant architectures (C₁-inv. QNN and C₃-inv. QNN), according to embodiments, substantially outperforms both the naive QNN and the classical NN.

By utilizing the symmetry-twirled gates previously described, these group-invariant models are forcefully constrained to respect fundamental physical symmetries. As a result, the models do not have to expend computational resources re-learning the physics of the molecule at every new distance. Instead, they inherently understand the underlying spatial relationships.

In this way, the disclosed method and hybrid framework can better capture the complex quantum chemistry of bond breaking with vastly superior accuracy, proving that directly injecting physical symmetry into the quantum hardware yields a far more robust and reliable computational tool.

According to an embodiment, the AI device 100 can be configured with a hybrid computing framework to achieve highly accurate molecular energy predictions by inherently respecting physical spatial symmetries. The AI device 100 can be implemented across a wide variety of domains, including, but not limited to, quantum chemistry, materials science, and biological research.

According to one or more embodiments of the present disclosure, the method and hybrid quantum computing framework can solve one or more technological problems in the existing technology, such as implementing highly accurate, symmetry-preserving molecular energy predictions through a group-equivariant quantum neural functional framework that can provide enhanced physical spatial awareness and inherent geometric consistency, while also reducing computational overhead.

For example, embodiments of the present disclosure can address the deficiencies of the related art naive quantum neural networks and classical density functional theory (DFT) models, which suffer from an inability to accurately resolve complex spatial geometries due to a lack of inherent three-dimensional spatial awareness, high error rates when processing spatially transformed inputs, and the prohibitive computational costs associated with redundantly training the network to recognize the exact same target molecule from different physical orientations.

For example, embodiments of the present disclosure can address the deficiencies of the related art parameterized quantum circuit architectures, which suffer from an inability to inherently respect fundamental physical symmetries at the gate level, leading to non-physical, mathematically inconsistent energy predictions, and an inability to reliably capture the complex quantum chemistry interactions necessary for advanced quantum chemistry, materials science, and biological applications.

Also, according to an embodiment, the AI device 100 configured with the disclosed method can be accessed or utilized via a variety of client terminals and edge devices, including a mobile terminal, a smart device, a robotic system, which can communicate with a quantum computing backend or cloud infrastructure.

For example, the hybrid quantum computing system can be applied in a wide range of advanced computational applications including a drug discovery platform, a materials design system, and an automated laboratory robot. For example, according to an embodiment, the automated laboratory robot can determine the precise quantum mechanical properties and exchange-correlation energies of a newly synthesized molecule, and based on this information, the robot can perform a more relevant testing or screening action, such as executing complex chemical reactions and compound filtering that more accurately addresses the spatial realities of the target molecular structure.

For example, methods and systems disclosed herein have broad applicability across a wide range of industries and technical fields that utilize quantum chemistry, molecular dynamics, and advanced materials science. The highly accurate molecular energy predictions generated by the disclosed group-equivariant quantum neural functional pipeline can be well suited for deployment on hybrid classical-quantum networks where deploying fully classical supercomputing clusters to redundantly calculate symmetry-variant molecular orientations is computationally prohibitive or highly inefficient.

Non-limiting examples of such applications include advanced molecular modeling tools and smart research platforms, such as automated drug screening interfaces, battery material simulators, catalyst design workstations, and interactive chemical simulation displays. The disclosed embodiments can allow researchers and manufacturers of such chemical products to rapidly and cost-effectively develop and deploy advanced spatial awareness and molecular mapping capabilities, utilizing symmetry-twirled quantum gates to accurately reconstruct complex electron correlation effects even for highly dynamic or dissociating molecular geometries.

Further, the disclosed method can provide significant advantages for the pharmaceutical and biotechnology industries, where robust spatial understanding of molecular interactions is desirable for drug safety and targeted therapeutic design. The trained quantum neural functional models can be integrated into advanced computer-aided drug design (CADD) systems or automated molecular docking simulators to manage complex binding affinity predictions, interaction modeling, and energy state evaluations. The ability to mathematically fuse physical symmetries directly into the quantum hardware allows for the creation of highly reliable predictive systems that can accurately compute exact exchange-correlation energies (e.g., predicting the binding energy of a drug molecule attaching to a folded protein) using a highly efficient, group-invariant quantum circuit.

In an enterprise or industrial context, the method can be used to develop and deploy specialized autonomous algorithms for chemical manufacturing, automated material discovery, high-throughput energy storage testing, and advanced metallurgical analysis. This enables companies to build powerful quantum-chemical simulation tools that construct complete, mathematically consistent energy landscapes of complex, evolving molecular environments from a unified theoretical framework, thereby streamlining research and development operations and reducing massive classical hardware overhead.

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, Python, PUP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling an artificial intelligence (AI) device, the method comprising:
generating, by a processor in the AI device, a real-space electron density for a target system;
encoding a representation of the real-space electron density into a multi-qubit quantum state;
processing the multi-qubit quantum state using a parameterized quantum circuit, wherein the parameterized quantum circuit includes a quantum neural network configured to be equivariant to an orthogonal group O(3) or finite subgroups of the orthogonal group O(3);
measuring an output of the parameterized quantum circuit to obtain spatial weighting coefficients;
calculating an exchange-correlation (XC) energy contribution by combining the spatial weighting coefficients with one or more analytical primitive energy-density terms; and
outputting the exchange-correlation (XC) energy contribution.

2. The method of claim 1, further comprising:
updating the real-space electron density for the target system based on Kohn-Sham equations of a density functional theory (DFT) calculation using the XC energy contribution;
iterating the generating the real-space electron density, the encoding the representation of the real-space electron density, the processing the multi-qubit quantum state, the measuring the output of the parameterized quantum circuit, the calculating the exchange-correlation (XC) energy contribution, and the updating the real-space electron density within a self-consistent field (SCF) loop until a convergence criterion for a ground-state energy and an electron density is satisfied based on at least one condition; and
in response to the convergence criterion being satisfied based on the at least one condition, outputting converged ground-state data.

3. The method of claim 2, wherein the updating the real-space electron density includes:
utilizing a newly calculated Kohn-Sham potential comprising an exchange-correlation potential as a functional derivative of a Kohn-Sham total energy to generate a new charge density and an estimate of the Kohn-Sham total energy.

4. The method of claim 2, wherein the at least one condition for the convergence criterion includes at least one of:
a change in the ground-state energy between successive iterations of the SCF loop falling below a first predefined threshold;
a change in the electron density between successive iterations of the SCF loop falling below a second predefined threshold; or
a change in a Kohn-Sham potential between successive iterations of the SCF loop falling below a third predefined threshold.

5. The method of claim 2, further comprising:
executing, by the AI device, an automated testing or screening action for a chemical reaction, a compound filtering, or a molecular dissociation simulation based on the converged ground-state data.

6. The method of claim 1, wherein the generating the real-space electron density and the calculating the XC energy contribution are performed by a classical computing subsystem of the AI device, and
wherein the encoding the representation, the processing the multi-qubit quantum state, and the measuring the output are performed by a quantum computing subsystem of the AI device.

7. The method of claim 1, wherein the parameterized quantum circuit includes symmetry-twirled gates configured to project quantum operations into a symmetry-invariant subspace by averaging a base quantum operator across possible symmetry transformations in the orthogonal group O(3) or the finite subgroups of the orthogonal group O(3).

8. The method of claim 1, wherein the encoding the representation of the real-space electron density into the multi-qubit quantum state includes mapping classical density grid data into the multi-qubit quantum state utilizing an encoding module configured to perform at least one of amplitude embedding, basis embedding, angle encoding, rotation encoding, Hamiltonian embedding, squeezing embedding, or displacement embedding.

9. The method of claim 1, further comprising:
downsampling, prior to the encoding, the real-space electron density on a three-dimensional grid to generate a reduced-length vector of density-derived input features,
wherein the representation of the real-space electron density encoded into the multi-qubit quantum state includes the reduced-length vector.

10. The method of claim 1, wherein the one or more analytical primitive energy-density terms include a Local Density Approximation (LDA) baseline evaluated by the processor, and
wherein the calculating the XC energy contribution includes multiplying the spatial weighting coefficients by the analytical primitive energy-density terms at respective grid points and integrating over a three-dimensional spatial grid.

11. The method of claim 1, wherein the target system includes a molecule or a periodic solid, and
wherein the method further comprises:
evaluating classical components of a total energy for the target system based on the real-space electron density, the classical components including a Kohn-Sham kinetic energy, an external energy from electron-nuclei interactions, and a Hartree energy.

12. An artificial intelligence (AI) device, comprising:
a memory configured to store information for a target system; and
a controller configured to:
generate a real-space electron density for the target system,
encode a representation of the real-space electron density into a multi-qubit quantum state,
process the multi-qubit quantum state using a parameterized quantum circuit, wherein the parameterized quantum circuit includes a quantum neural network configured to be equivariant to an orthogonal group O(3) or finite subgroups of the orthogonal group O(3),
measure an output of the parameterized quantum circuit to obtain spatial weighting coefficients,
calculate an exchange-correlation (XC) energy contribution by combining the spatial weighting coefficients with one or more analytical primitive energy-density terms, and
output the exchange-correlation (XC) energy contribution.

13. The AI device of claim 12, wherein the controller is further configured to:
update the real-space electron density for the target system based on Kohn-Sham equations of a density functional theory (DFT) calculation using the XC energy contribution,
iterate generating the real-space electron density, encoding the representation of the real-space electron density, processing the multi-qubit quantum state, measuring the output of the parameterized quantum circuit, calculating the exchange-correlation (XC) energy contribution, and updating the real-space electron density within a self-consistent field (SCF) loop until a convergence criterion for a ground-state energy and an electron density is satisfied based on at least one condition, and
in response to the convergence criterion being satisfied based on the at least one condition, output converged ground-state data.

14. The AI device of claim 13, wherein the controller is further configured to:
utilize a newly calculated Kohn-Sham potential including an exchange-correlation potential as a functional derivative of a Kohn-Sham total energy to generate a new charge density and an estimate of the Kohn-Sham total energy for updating the real-space electron density.

15. The AI device of claim 12, wherein the controller includes a classical computing subsystem and a quantum computing subsystem,
wherein the classical computing subsystem is configured to generate the real-space electron density and calculate the XC energy contribution, and
wherein the quantum computing subsystem is configured to encode the representation of the real-space electron density, process the multi-qubit quantum state, and measure the output of the parameterized quantum circuit.

16. The AI device of claim 12, wherein the parameterized quantum circuit includes symmetry-twirled gates configured to project quantum operations into a symmetry-invariant subspace by averaging a base quantum operator across possible symmetry transformations in the orthogonal group O(3) or the finite subgroups of the orthogonal group O(3).

17. The AI device of claim 12, wherein the target system includes a molecule or a periodic solid, and
wherein the controller is further configured to:
evaluate classical components of a total energy for the target system based on the real-space electron density, the classical components comprising a Kohn-Sham kinetic energy, an external energy from electron-nuclei interactions, and a Hartree energy.

18. The AI device of claim 12, wherein the controller is further configured to:
map classical density grid data into the multi-qubit quantum state utilizing an encoding module configured to perform at least one of amplitude embedding, basis embedding, angle encoding, rotation encoding, Hamiltonian embedding, squeezing embedding, or displacement embedding to encode the representation of the real-space electron density.

19. A non-transitory computer readable medium storing computer-executable instructions that when executed by one or more processors, cause the one or more processors to perform the operations of:
generating a real-space electron density for a target system;
encoding a representation of the real-space electron density into a multi-qubit quantum state;
processing the multi-qubit quantum state using a parameterized quantum circuit, wherein the parameterized quantum circuit includes a quantum neural network configured to be equivariant to an orthogonal group O(3) or finite subgroups of the orthogonal group O(3);
measuring an output of the parameterized quantum circuit to obtain spatial weighting coefficients;
calculating an exchange-correlation (XC) energy contribution by combining the spatial weighting coefficients with one or more analytical primitive energy-density terms; and
outputting the exchange-correlation (XC) energy contribution.

20. A hybrid quantum-classical computing system for calculating ground-state electronic properties of a target using density functional theory (DFT), the hybrid quantum-classical computing system comprising:
a classical computing subsystem comprising at least one classical processor and a memory storing a classical DFT engine and a library of energy-density primitives;
a quantum computing subsystem in communication with the classical computing subsystem, the quantum computing subsystem comprising a quantum processor having a plurality of qubits;
wherein the classical computing subsystem and the quantum computing subsystem are collectively configured to execute a self-consistent field (SCF) loop by:
executing, via the classical processor, the classical DFT engine to generate an initial real-space electron density for the target and calculate a Kohn-Sham kinetic energy, an external energy from electron-nuclei interactions, and a Hartree energy;
transmitting, from the classical computing subsystem to the quantum computing subsystem, encoded data representing the initial real-space electron density;
preparing, on the quantum processor, a multi-qubit quantum state based on the encoded data;
processing the multi-qubit quantum state on the quantum processor using a parameterized quantum circuit, wherein the parameterized quantum circuit comprises a quantum neural network configured to be explicitly equivariant to an orthogonal group O(3) or finite subgroups of the orthogonal group O(3);
measuring an output of the parameterized quantum circuit to obtain a set of spatial weighting coefficients and transmitting the set of spatial weighting coefficients back to the classical computing subsystem;
calculating, via the classical processor, an exchange-correlation (XC) energy contribution by combining the set of spatial weighting coefficients with the energy-density primitives; and
updating, via the classical DFT engine, Kohn-Sham equations using the XC energy contribution to generate an updated real-space electron density until a convergence criterion is satisfied,
wherein the classical computing subsystem is configured to in response to the convergence criterion being satisfied, output converged ground-state data.
